(19) United States
(12) Patent Application Publication
(10) Pub. No.: US 2006/0235913 A1
(43) Pub. Date: Oct. 19, 2006

(54) Software product for processing user interfaces of digital device and method for processing user interfaces

(75) Inventor: Young Kwan Jeong, Gyeonggi-do (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/370,834

(22) Filed: Mar. 9, 2006

(30) Foreign Application Priority Data
Mar. 11, 2005 (KR) 20347/2005

(51) Int. Cl. G06F 15/00

(52) U.S. Cl. 708/200

(57) ABSTRACT

Disclosed is a user interface processing software architecture of a digital device. The user interface processing software architecture of a digital device provides software that can effectively process complicated events created by various user interfaces or the like of a functionally complex digital device. To this end, the software architecture of the present invention divides functions related to user interfaces to be processed by the digital device into a plurality of state modules. Each of the state modules separately has a key handler and an event handler, and independently processes key inputs of a user and events created when the digital device in a specific state.

### BACKGROUND

The description relates to a software product for processing user interfaces of a digital device and a method for processing the user interfaces, wherein various events created in the digital device that has become functionally complicated due to a variety of complex functions can be processed effectively.

Recently, a digital device tends to become a multi-functional and complex device, that is, functions of conventional individual products are merged into a device that performs a variety of functions. For example, there has appeared an optical disc device having the functions of a set-top box, personal video recorder (PVR), Blu-ray disc-rewritable (BD-RE) recorder, CD and DVD player, and the like.

Such an optical disc device uses optical information recording technology, and is connected to a television set or applied to an external recording device, such as a DVD-RAM drive, for a computer.

Most of such digital devices perform predetermined operations in response to user's control commands received through keys provided at a remote control or a front end of a product.

For example, while an optical disc device plays back a title recorded in an optical disc, if the optical disc device receives a key input, which requests a change from the title currently being played to another title and playback of the changed title, from a user, it analyzes the key inputted by the user and recognizes it as a title switching command. After recognizing the title switching command, the optical disc device sends the corresponding key input to a user interface processing part, i.e., a top-level application part of software, and performs operations needed for switching the titles.

In addition, if a program that automatically cuts off the power of the optical disc device upon completion of the playback of a title is executed, the optical disc device checks whether the playback of the optical disc has been completed. If it is checked that there is no signal to be played back, the optical disc device sends an event to the user interface part, i.e., the top-level application part of software, to notify the fact and automatically performs an operation needed for cutting off the power.

If the number of events processed by such a digital device is small, the digital device can operate without any special problems. However, if the numbers of cases of key inputs and events become large and diverse, time required for performing the operations according to the key inputs or events of the digital device is extended, and thus, the digital device cannot efficiently process the corresponding operations.

### SUMMARY

It is an object of the present invention to provide a software product for processing user interfaces of a digital device and a method for processing the user interfaces, wherein complicated events created by various user interfaces and the like of a functionally complex digital device can be effectively processed.

According to one aspect of the present invention for achieving the object, there is provided a method for processing user interfaces of a digital device, comprising: classifying states of the digital device into a plurality of states according to functions related to the user interfaces, the plurality of states being structurally formed to be connected to one state of the plurality of states through radial paths centered on the state; receiving predetermined control authority for processing a key input or an event created inside the digital device in the corresponding state, from a previous state along the paths if the digital device performs one of the plurality of states; and processing the key input or the event according to the received control authority.

According to another aspect of the present invention, there is provided a software product for processing user interfaces of a digital device, comprising a plurality of state modules that can be implemented in a computer and can process respective functions corresponding to a plurality of states obtained by classifying the state of the digital device according to functions related to the user interfaces.

The plurality of state modules are structurally formed to be connected to one state module of the plurality of state modules through radial paths centered on the state module.

Each of the state modules includes at least one sub-state module, a key handler, and an event handler.

The sub-state module processes a function related to a user interface to be processed in a corresponding state module. The key handler controls the sub-state module in response to a key inputted by a user if the state of the digital device is switched along the paths and then corresponds to its state. The event handler controls the sub-state module in response to an event created inside the digital device if the state of the digital device is switched along the paths and then corresponds to its state.

Preferably, the key handler calls the sub-state module if the inputted key can be processed by the key handler in the corresponding state, or calls a key handler of a neighboring state module along the paths if the inputted key is intended to switch the state.

Preferably, the event handler calls the sub-state module if the created event can be processed by the event handler in the corresponding state, or calls an event handler of a neighboring state module along the paths if the created event is intended to switch the state.

Preferably, the state module structurally placed at the center of the radial paths among the plurality of state modules is an idle state module that performs a function related to a user interface created for the first time after the digital device is initialized.

Preferably, the other state modules except the state module structurally placed at the center of the radial paths among the plurality of state modules processes functions that are classified by means of a predetermined method among functions of providing a user with graphical display of certain information generated while the state module placed at the center is in operation.

### BRIEF DESCRIPTION OF THE DRAWINGS

The above and other objects, features and advantages of the present invention will become apparent from the following description of preferred embodiments given in conjunction with the accompanying drawings, in which:

FIG. 1 illustrates a user interface processing software architecture of a digital device according to an embodiment of the present invention;

FIG. 2 illustrates a user interface processing software architecture of a digital device according to another embodiment of the present invention; and

FIG. 3 illustrates an example in which a user interface processing software architecture according to an embodiment of the present invention is applied to an optical disc device.

### DETAILED DESCRIPTION OF THE INVENTION

Hereinafter, preferred embodiments of the present invention will be described in detail with reference to the accompanying drawings.

When it is considered that specific descriptions of known relevant constitutions or functions may make the subject matter of the present invention obscure upon explanation of the present invention, detailed descriptions thereof will be omitted.

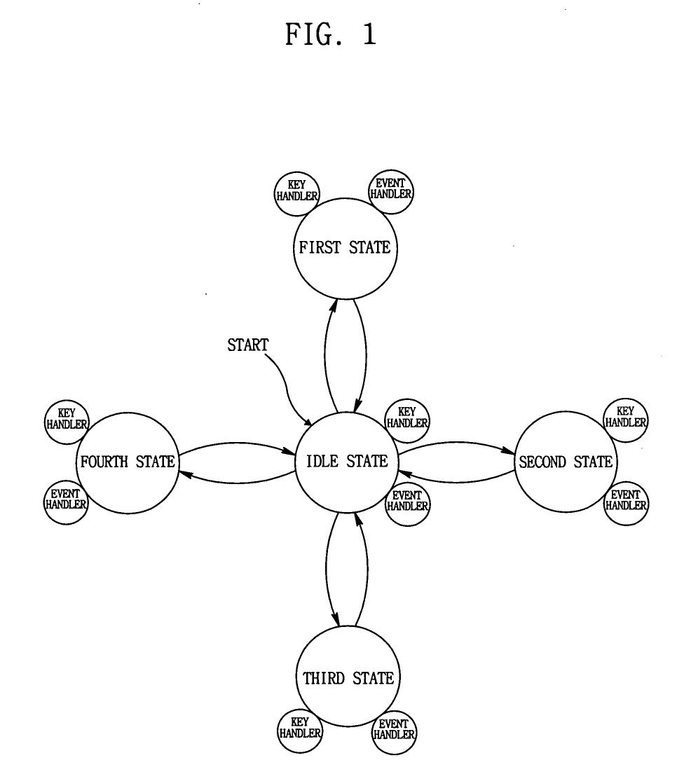

FIG. 1 illustrates a user interface processing software architecture of a digital device according to an embodiment of the present invention.

The user interface processing software architecture of a digital device according to the present invention can be proposed as an optimum structure for a user interface processing module, i.e., a top-level application part of software.

The software architecture of the present invention is proposed as a structure for a program that processes events created in relation to user interfaces of a digital device. A user interface of a digital device includes receipt of a certain key input from a user, or display of a variety of information on operational states of the digital device through a certain display unit. Accordingly, on the basis of hardware, a software program to which the software architecture of the present invention is applied connects a key input from a user to an operation of the digital device, processes various events created inside the digital device, and displays information on the events.

The software architecture of the present invention includes certain state modules into which events processed by the digital device are classified according to operations processed with a series of associations, i.e., events having high correlation therebetween. In other words, the state modules represent certain states into which events having high correlation therebetween are grouped. Accordingly, in the following description, the terms ‘state’ and ‘state module’ are interchangeable. However, each state corresponds to a state module included in the user interface software architecture.

Furthermore, in connection with user interfaces, events include events created by a user and events created by an internal system. The events created by the user include a key input and the like. The events created by the internal system may be created by means of an operation reserved through an internal timer of the system, interrupt of transmission of data being received, errors in the internal system or program, and the like. Although these events may not be clearly classified, it is not a critical factor in the present invention.

Such state modules can be classified according to functions observed by a user rather than a digital device. Thus, it is preferred that the state modules be classified according to user interfaces.

For example, suppose an optical disc device with complex functions of a personal video recorder (PVR), Blu-ray disc-rewritable (BD-RE) recorder CD and DVD player, and the like. In case of the multi-functional complex digital device, state modules can be classified according to combined functions. Although the functions are combined and integrated, a user of such a complex digital device wants to separately access the respective functions of conventional individual devices, and to be provided with user interfaces for the separate functions of the combined individual devices.

Due to the functionally classified architecture, a program coded according to an embodiment of the present invention has superior portability enabling easy application thereof to other systems through simple modifications. The porting modifications include addition of a new state module, and delete or modification of an existing state module, and can be relatively simply accomplished due to independency of the state module. In addition, since the software architecture of the present invention is divided according to functions, it is very advantageous to update or debugging thereof.

In the embodiment of FIG. 1, the software architecture of the present invention includes an idle state module and first to fourth state modules. The idle state module is connected to all the other state modules, but each state module is connected only to the idle state module.

Each state module is independent. Each state module has control authority for all events created while a digital device is being operated in a corresponding state, i.e., events created by key inputs or an internal system. Accordingly, the first state module processes events created by all key inputs or the internal system while the digital device is being operated in a first state.

As for the control authority, a software program according to the configuration of the present invention is basically managed by a manager called a state machine. The state machine transfers the occurrence of an event by a key input or the internal system to a corresponding state according to the control authority among a plurality of state modules to be described below.

The idle state module represents an initial state after a system initialization operation, such as a state where the system is powered on or awakened from a sleeping mode. Here, the sleeping mode is a state where the system that has been reserved to start an operation when a certain time is reached only checks time without performing a normal operation until the corresponding certain time is reached. The idle state module is the most basic module and becomes the center of all the state modules. The idle state module can process an event and the like created by a key that should be processed in common in the respective states.

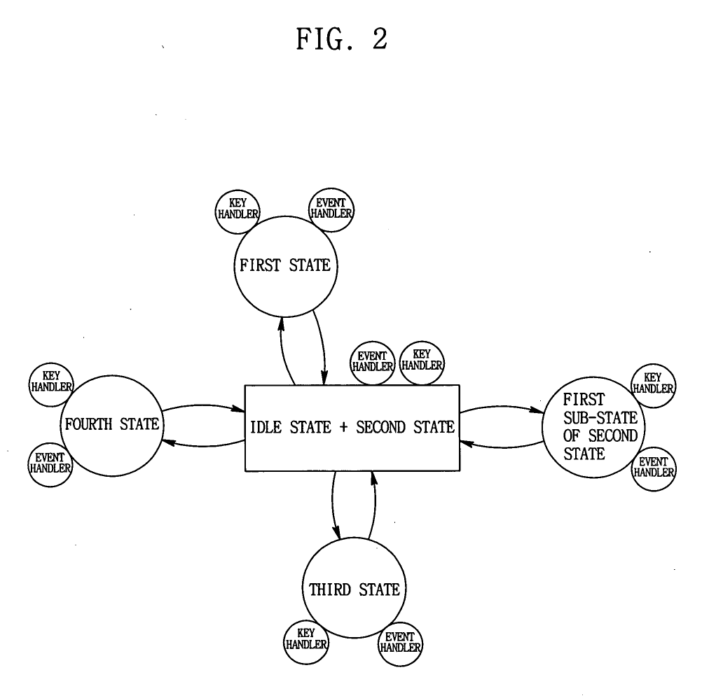

According to the embodiment, the idle state module can include at least one state module that can be functionally separated and independently formed. For example, when the structure of a state module is very complicated and can be classified into multiple states, the idle state module can include a basic state, which is shown in FIG. 2.

Referring to FIG. 2, a second state is included in the idle state module, and there is a module for a first sub-state of the second state. It can be considered that the second state module doest not substantially exist. Here, the module for the first sub-state of the second state processes an event created in the course of the second state.

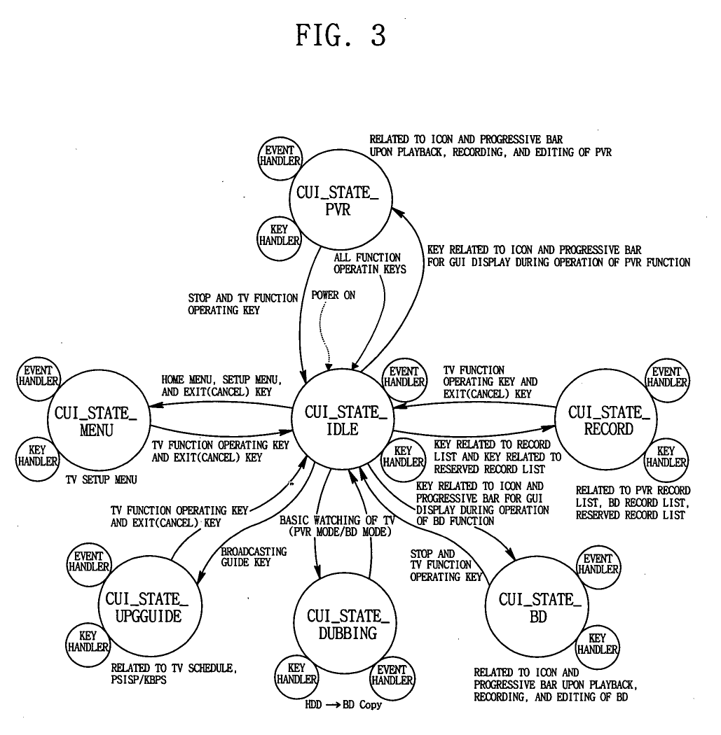

For example, suppose that a user of an optical disc complex digital device inputs a key, which is related to an icon or a progressive bar, for GUI display while the PVR function of the device is being performed. Displaying an icon or a progressive bar should be operated in connection with a playback state, and a display state should be maintained or deleted according to a user's need. In this case, a PVR state does not process all these general user interfaces. Instead, the idle state module is caused to process user's key input or an internal event related to a basic PVR function, and a state where the progressive bar is displayed can be configured into a separate state module. This will be explained again with reference to FIG. 3.

Referring again to FIGS. 1 and 2, description will be made.

Each state module includes one or more sub-state modules. The sub-state modules represent respective events included in one state module, and perform various functions and roles to be processed in the state module in connection with user interfacing.

Each state module includes a key handler and an event handler.

The key handler processes a key inputted by a user in a current state. To this end, the key handler determines whether the inputted key can be processed in the state module in which the key handler is included. If it is determined that the key can be processed, the key handler calls a corresponding sub-state module to process the inputted key. If it is determined that the key cannot be processed, the key handler ignores the key. When the key handler has to hand over control authority to the idle state module according to the inputted key, the key handler calls a key handler of the idle state module and hands over the control authority.

Exceptionally, the key handler of the idle state module determines whether the inputted key can be processed in the idle state module in which the key handler is included. If it is determined that the key can be processed, the key handler calls a corresponding sub-state module to process the inputted key or hands over control authority to another state module. If it is determined that the key cannot be processed, the key handler ignores the inputted key. If the key handler of the idle state module hands over control authority to another state module, keys inputted thereafter are processed by a key handler of the state module that has received the control authority.

The event handler checks an event created by an internal system and performs control to process the corresponding event, in a corresponding state where it has control authority. The event handler determines whether an event created in the corresponding state can be processed in the state module in which the event handler is included. If it is determined that the event can be processed, the event handler calls a corresponding sub-state module to process the event. If it is determined that the event cannot be processed, the event handler ignores the event. If the event handler has to hand over control authority to the idle state module according to the created event, it calls the event handler of the idle state module and hands over the control authority.

The event handler of the idle state module, in the same manner as the corresponding key handler, determines whether an event created by the internal system in the idle state can be processed in the idle state module. If it is determined that the event can be processed, the event handler calls a corresponding sub-state module to process the event or hands over control authority to another state module that can process the event. If it is determined that the event cannot be processed, the event handler ignores the event.

According to another embodiment of the present invention, an event key handler can operate to perform the functions of the key handler.

Consequently, the user interface software architecture of the present invention has an individual event manager (for example, a key handler or an event handler) for each state module classified according to predetermined states. Accordingly, a supervisor that processes all events related to user interfaces does not manage all key inputs or events. Thus, even though the number of cases to be produced increases, only the number of states increases and there is no considerable change in the number of cases that each state processes or determines. This is because those events that cannot be processed are ignored, which intensifies portability and extensibility of the software architecture of the present invention.

Since the state modules are classified according to user interfaces, transitions between state modules are performed by key handling of a user and events created inside the system. As describe above, although transitions from the idle state module to the first to fourth state modules or transition in the reverse direction can be performed, transitions among the first to fourth state modules cannot be performed. In FIG. 1, such transitions between the state modules are designated by arrows.

FIG. 3 illustrates an example in which the user interface processing software architecture according to an embodiment of the present invention is applied to an optical disc device. Hereinafter, an example for implementing the user interface processing software architecture according to the present invention will be explained with reference to FIG. 3.

The optical disc device to which the software architecture according to an embodiment of the present invention shown in FIG. 3 is applied has complex functions of a personal video recorder (PVR), Blu-ray disc-rewritable (BD-RE) recorder, and CD and DVD player, and is connected to an image displaying device such as a digital television (DTV).

The software architecture of FIG. 3 includes state modules, such as an idle module (CUI_STATE_IDLE), a menu module (CUI_STATE_MENU), a PVR module (CUI_STATE_PVR), a record module (CUI_STATE_RECORD), a UPG (User_Program_Guide), a guide module (CUI_STATE_UPGGUIDE), a dubbing module (CUI_STATE_DUBBING), and a Blu-ray disc (BD) module (CUI_STATE_BD). Each state module independently has a key handler and an event handler.

The software architecture of FIG. 3 is based on the embodiment of FIG. 2. For example, the PVR module does not process a key input related to the basic function of the PVR but processes a key input related to GUI created while the PVR function is performed. The basic function of the PVR is processed by the idle module.

For example, if a key input requesting the display of a specific icon or a progressive bar is inputted while the PVR function is performed in the idle state, the key handler of the idle state module hands over control authority to the PVR module. The key handler of the PVR module calls a sub-state module that enables a progressive bar to be displayed according to the inputted key, thereby performing an operation corresponding to the inputted key.

If the icon or the progressive bar disappears due to time-out or a key inputted by a user, control authority is transferred to the idle module. In addition, if the user inputs a key for displaying the icon or the progressive bar again on a screen using a confirm key or a screen display key, the idle state is switched to the PVR state.

Besides, the PVR module includes sub-state modules describe below, and the key handler of the PVR module processes corresponding key inputs.

The PVR state includes a state where a progressive bar is displayed while a transport stream (T/S) is in progress (CUI_STATE_PVR_PGBAR_LIVE), a state where a progressive bar is displayed while a recorded program is played back (CUI_STATE_PVR_PGBAR_PROG), a state where an icon indicates that recording is in progress (CUI_STATE_PVR_ICON_REC), a state where an icon indicates that a T/S is in progress (CUI_STATE_PVR_ICON_TS), a state where an icon indicates that playing back a recorded program is in progress (CUI_STATE_PVR_ICON_PB), and a state where a dialog for directly setting record duration is displayed (CUI_STATE_PVR_IR_DLG).

The Blu-ray disc (BD) state operates in the same manner as the PVR state. As for the Blu-ray disc (BD) state, if a user inputs a key for GUI display while the BD function is performed in the idle state, the idle state is switched to the BD state. In addition, the control authority of the BD state is returned to the idle state when the icon or the progressive bar disappears due to time-out or by the user.

As for the RECORD state, the idle state is switched to the record state when access to a record list is made by means of a record list key or access to a reservation list is made by means of a reservation list key. The function of record list or reservation list is provided to a user. When a function on a title list, such as sorting, detailed information, name change or the like is performed on the record list, the optical disc device is in the record state. Even when the optical disc device completes an editing function on the record list and returns to the record list, it is still in the record state.

As for the MENU state, the idle state is switched to the menu state by a home menu key or an initial setting key. A set-up menu may be provided to a user. To enable entrance into the menu state from all the other states, the key handler of each state module hands over control authority to the key handler of the menu module through the idle state if there is a key input.

As for the UPG GUIDE state, the idle state is switched to the UPG GUIDE state by means of a broadcasting guide key. In the UPG GUIDE state, broadcasting information can be displayed using GUI by a program & system information protocol (PSIP) engine.

As for the DUBBING state, the idle state is switched to the DUBBING state using GUI named “Copy” in sub-menus of each title list in a hard disc drive (HDD) record list. That is, this means a state where content stored in the HDD is to be moved to a Blu-ray disc. The HDD is in a playback state and the Blu-ray disc is in the record state. If the progressive bar disappears by the user or due to time-out while a copy operation is in progress, the dubbing state is switched to the idle state. Even at this time, the idle state can be switched again to the dubbing state by a confirm key or the like.

As described above, in an optical disc device that reads data from a high-density optical disc such as a Blu-ray disc on which video and audio data are recorded with high-density, operation commands inputted from a remote control or a front key by a user, operation commands inputted by means of an external input signal, and operation commands inputted by means of a timer or an event can be efficiently processed through a key handler or an event handler.

As described above, according to the user interface processing software architecture of the preset invention, user interfaces of a digital device that becomes more complicated and diverse day by day can be effectively processed.

Furthermore, with the functionally divided architecture, a user interface processing software program coded according to an embodiment of the present invention has superior portability that enables the program to be easily applied to other systems through simple modifications. The porting modifications include addition of a new state module, and delete or modification of an existing state module, and can be relatively simply accomplished by the independency of the state module.

In addition, since a software program coded by the user interface processing software architecture according to an embodiment of the invention is divided according to functions, it has very excellent extensibility in updating, debugging, and adding a new function.

When the present invention is implemented into computer software, components of the present invention can be substituted with code segments needed for performing necessary operations. A program or a code segment can be stored in a medium that can be processed by a microprocessor, and can be transmitted as computer data modulated with carrier waves through a transmission medium or a communication network.

Media that can be processed by a microprocessor include those that can transfer and store information, such as an electronic circuit, a semiconductor memory device, a ROM, a flash memory, an EEPROM, a floppy disc, an optical disc, a hard disc, an optical fiber, and a wireless network. In addition, the computer data include data that can be transmitted through an electrical network channel, an optical fiber, an electromagnetic field, a wireless network, and the like.

Although the present invention has been described and illustrated in connection with the most preferred embodiments, it is not limited to the aforementioned specific embodiments. It will be readily understood by those skilled in the art that various modifications and changes can be made thereto without departing from the spirit and scope of the present invention defined by the appended claims. Such modifications and changes should not be construed separately from the technical spirit and scope of the present invention.

What is claimed is:

1. A method for processing user interfaces of a digital device, comprising:
classifying states of the digital device into a plurality of states according to functions related to the user interfaces, the plurality of states being structurally formed to be connected to one state of the plurality of states through radial paths centered on the state;
receiving predetermined control authority for processing a key input or an event created inside the digital device in the corresponding state, from a previous state along the paths if the digital device performs one of the plurality of states; and
processing the key input or the event according to the received control authority.

2. The method as claimed in claim 1, wherein the processing step comprises:
processing a user interface corresponding to the key if the key can be processed in the corresponding state; and
transferring the control authority to a neighboring state along the paths if the key is intended to switch the state.

3. The method as claimed in claim 1, wherein the processing step comprises:
processing a user interface corresponding to the event if the event can be processed in the corresponding state; and
transferring the control authority to a neighboring state along the paths if the event is intended to switch the state.

4. The method as claimed in claim 1, wherein the state structurally placed at the center of the radial paths among the plurality of states performs a function related to a user interface created for the first time after the digital device is initialized.

5. The method as claimed in claim 1, wherein the other states except the state structurally placed at the center of the radial paths among the plurality of states processes functions that are classified by means of a predetermined method among functions of providing a user with graphical display of certain information generated while the state placed at the center is in operation.

6. A software product for processing user interfaces of a digital device, comprising:
a plurality of state modules that can be implemented in a computer and can process respective functions corresponding to a plurality of states obtained by classifying the state of the digital device according to functions related to the user interfaces,
wherein the plurality of state modules are structurally formed to be connected to one state module of the plurality of state modules through radial paths centered on the state module, and
each of the state modules includes:
at least one sub-state module for processing a function related to a user interface to be processed in a corresponding state module;
a key handler for controlling the sub-state module in response to a key inputted by a user if the state of the digital device is switched along the paths and then corresponds to its state; and
an event handler for controlling the sub-state module in response to an event created inside the digital device if the state of the digital device is switched along the paths and then corresponds to its state.

7. The software product as claimed in claim 6, wherein the key handler calls the sub-state module if the inputted key can be processed by the key handler in the corresponding state, or calls a key handler of a neighboring state module along the paths if the inputted key is intended to switch the state.

8. The software product as claimed in claim 6, wherein the event handler calls the sub-state module if the created event can be processed by the event handler in the corresponding state, or calls an event handler of a neighboring state module along the paths if the created event is intended to switch the state.

9. The software product as claimed in claim 6, wherein the state module structurally placed at the center of the radial paths among the plurality of state modules is an idle state module that performs a function related to a user interface created for the first time after the digital device is initialized.

10. The software product as claimed in claim 6, wherein the other state modules except the state module structurally placed at the center of the radial paths among the plurality of state modules processes functions that are classified by means of a predetermined method among functions of providing a user with graphical display of certain information generated while the state module placed at the center is in operation.
